(19) United States
(12) Patent Application Publication
(10) Pub. No.: US 2014/0080706 A1
(43) Pub. Date: Mar. 20, 2014

(54) METHOD OF PREPARING AN AQUEOUS TANK MIX COMPRISING A BASE

(71) Applicant: BASF SE, Ludwigshafen (DE)

(72) Inventors: Gerhard Schnabel, Elsenfeld (DE); Marc Nolte, Mannheim (DE); Mariano Ignacio Etcheverry, Mannheim (DE); Gerhard Genari, Limburgerhof (DE); Thomas Kröhl, Schriesheim (DE); Matthias Bratz, Maxdorf (DE); Terrance M. Cannan, Raleigh, NC (US); Steven Bowe, Apex, NC (US); Chad Brommer, Raleigh, NC (US); John Frihauf, Raleigh, NC (US); Charles W. Finch, Garner, NC (US); Walter Thomas, Fuquay-Varina, NC (US)

(73) Assignee: BASF SE, Ludwigshafen (DE)

(21) Appl. No.: 14/122,833

(22) PCT Filed: May 25, 2012
(86) PCT No.: PCT/EP2012/059827

§ 371 Date: Nov. 27, 2013

Related U.S. Application Data
(60) Provisional application No. 61/491,937, filed on Jun. 1, 2011.
(60) Provisional application No. 61/514,084, filed on Aug. 2, 2011.
(60) Provisional application No. 61/554,524, filed on Nov. 2, 2011.
(60) Provisional application No. 61/613,528, filed on Mar. 21, 2012.

(30) Foreign Application Priority Data
Jun. 7, 2011 (EP) 11168980.8

(51) Int. Cl. A01N 25/02; A01N 37/40; A01N 57/20

(52) U.S. Cl. CPC A01N 25/02; A01N 57/20; A01N 37/40
USPC 504/127; 504/206

(57) ABSTRACT

The present invention relates to a method of controlling undesired vegetation, and/or phytopathogenic fungi and/or undesired insect attack and/or regulating the growth of plants, which comprises the steps of A) preparing an aqueous tank mix which has a tank mix acidity of at least pH 5.0 comprising contacting a pesticide formulation, water, a base, and optionally an auxiliary; and B) allowing a pesticidal effective amount of said tank mix to act on crops, their habitat, on the undesired vegetation, on the respective pests, and/or on seed of said crops. It also relates to a use of a base for preparing an aqueous tank mix as defined in any of claims 1 to 10 which a tank mix acidity of at least pH 5.0.

The present invention relates to a method of controlling undesired vegetation, which comprises the steps of A) preparing an aqueous tank mix which has a tank mix acidity of at least pH 5.0 comprising contacting an pesticide formulation (e.g. auxin herbicide formulation), water, and optionally a base and/or an auxiliary; and B) allowing a herbicidal effective amount of said tank mix to act on crops, their habitat or on seed of said crops. The invention also relates to said aqueous tank comprising an pesticide formulation (e.g. auxin herbicide formulation), a base and water; and to a method for preparing said aqueous tank mix comprising the step of contacting an pesticide formulation (e.g. auxin herbicide formulation), a base and water. The invention further relates to a method of controlling undesired vegetation, and/or phytopathogenic fungi and/or undesired insect attack and/or regulating the growth of plants, which comprises the steps of A) preparing an aqueous tank mix which has a tank mix acidity of at least pH 5.0 comprising contacting a pesticide formulation, water, a base, and optionally an auxiliary; and B) allowing a pesticidal effective amount of said tank mix to act on crops, their habitat, on the undesired vegetation, on the respective pests, and/or on seed of said crops. It also relates to a use of a base for preparing an aqueous tank mix as defined in any of claims 1 to 10 which has a tank mix acidity of at least pH 5.0. The preferred embodiments of the invention mentioned herein below have to be understood as being preferred either independently from each other or in combination with one another.

Often, pesticides such as auxin herbicides are applied in a medium, that results in an at least partly protonated form in an equilibrium of the active (i.e. in an acidic environment at pH below 5.0), as the protonated form is said to lead to an improved leaf uptake and thus biological performance.

In many case the pH value of tank mixes is acidic and below 5.0. This is because the water used for the preparation of the tank mix is acidic, such as acidic untreated natural water. In other cases, the addition of acidic pesticides (e.g. glyphosate), acidic additives (e.g. Dash®), or other additives (e.g. ammonium sulfate AMS), could result in an acidic tank mixture.

When using auxin herbicides for controlling undesired vegetation usually a herbicidal effective amount of said auxin herbicides is applied. However, the application can in unfavourable conditions result in unwanted phytotoxic damage in neighboring areas in which other crops (e.g. dicotyledon crops) grow. Another problems when using auxin herbicides for controlling undesired vegetation is that the herbicidal effect may still be increased. Another problem when using pesticides in crop protection is that the pesticidal effect may still be increased. Object of the present invention was to overcome the above mentioned problems.

The object was solved by a method of controlling undesired vegetation, which comprises the steps of
A) preparing an aqueous tank mix which has a tank mix acidity of at least pH 5.0 comprising contacting an auxin herbicide formulation, water, and optionally a base and/or an auxiliary; and
B) allowing a herbicidal effective amount of said tank mix to act on crops, their habitat or on seed of said crops.

In another form the object was solved by a method of controlling undesired vegetation, and/or phytopathogenic fungi and/or undesired insect attack and/or regulating the growth of plants, which comprises the steps of
A) preparing an aqueous tank mix which has a tank mix acidity of at least pH 5.0 comprising contacting a pesticide formulation, water, a base, and optionally an auxiliary; and
B) allowing a pesticidal effective amount of said tank mix to act on crops, their habitat, on the undesired vegetation, on the respective pests, and/or on seed of said crops.

In step A) an aqueous tank mix may be prepared comprising the step of contacting an pesticide formulation (e.g. auxin herbicide formulation), water and optionally a base and/or an auxiliary. The contacting may be achieved by mixing the components in any sequence. Preferably, the pesticide formulation (e.g. auxin herbicide formulation, such as a concentrated aqueous formulation, especially a SL formulation) is mixed with water and the base. The weight ratio of formulation to water is usually in a range of from 1:1 to 1:10,000, more preferably from 1:5 to 5,000, and in particular from 1:10 to 1:1000. Preferably, the contacting is done at ambient temperature, such as from 5 to 45° C.

The water is preferably untreated natural water, such as ground water, rain water collected in a water reservoir, river water, or lake water. For comparison, treated water relates to tap water, which has passed a sewage plant.

Typically, the tank mix contains at least 50 wt % water, preferably at least 60 wt %, more preferably at least 70 wt % and in particular at least 80 wt %.

The water may be soft, medium or hard water. Preferably it is medium or hard water. Usually, the water has a hardness of at least 5° dH, preferably at least 10° dH, more preferably at least 15° dH, and in particular at least 20° dH (German degrees of hardness). In another form the water contains at least 0.1 mmol/l, preferably at least 1.0 mmol/l, more preferably at least 2.0 mmol/l, even more preferably at least 3.0 mmol/l, and in particular at least 3.5 mmol/l of the sum of calcium ions and magnesium ions.

According to the invention, an aqueous tank mix which has a tank mix acidity of at least pH 5.0 was prepared. Preferably, the tank mix acidity corresponds to a pH of at least 6.0, better of at least 7.0, more preferably of at least 7.5, especially preferred of at least 8.0 and in particular of at least 8.5. The tank mix acidity may correspond to a pH of up to 13.0, preferably of up to 11.0 and in particular of up to 9.0. The tank mix acidity is usually determined as pH value at 20° C. without dilution of the tank mix.

Typically, in step A) at least one of components selected from the pesticide formulation (e.g. auxin herbicide formulation), the water, and/or the auxiliary is more alkaline than the tank mix acidity; and/or the base is added. Said components or said base are added in such an amount that the requested tank mix acidity is achieved. The term “more alkaline” means that the pH value is at least 0.5 unit, preferably at least 1.0 unit, more alkaline compared to the tank mix acidity.

In a preferred form of step A) the water is more alkaline than the tank mix acidity. For example, the water has a pH value which is at least 0.5 unit, preferably at least 1.0 unit, more alkaline compared to the tank mix acidity.

In another preferred form of step A) the pesticide formulation (e.g. auxin herbicide formulation) is more alkaline than the tank mix acidity. For example, the pesticide formulation (e.g. auxin herbicide formulation) has a pH value which is at least 0.5 unit, preferably at least 1.0 unit, more alkaline compared to the tank mix acidity. In case the formulation is not an aqueous composition, the pH is determined after 10-fold dilution with neutral water at 20° C.

In another preferred form of step A) the auxiliary is more alkaline than the tank mix acidity. For example, the auxiliary has a pH value which is at least 0.5 unit, preferably at least 1.0 unit, more alkaline compared to the tank mix acidity. In case the auxiliary is not an aqueous composition, the pH is determined after 10-fold dilution with neutral water at 20° C.

In more preferred form of step A) the base is added. This means that an aqueous tank mix is prepared by contacting an pesticide formulation (e.g. auxin herbicide formulation), water, a base and optionally an auxiliary.

In many cases of the state of the art the pH of tank mixes was acidic or even below pH 5. This was because either the water used for the preparation of tank mixtures had a pH of below 5.0, or because of the addition of acidic pesticides (e.g. glyphosate) or acidic auxiliaries (e.g. Dash®, ammonium sulfate AMS) could result in an acidic tank mixture.

In a more preferred form of step A)
a) at least one of the components selected from the pesticide formulation (e.g. auxin herbicide formulation), the water, and/or the auxiliary is more acidic than the tank mix acidity; as well as
b1) at least one of components selected from the pesticide formulation (e.g. auxin herbicide formulation), the water, and/or the auxiliary is more alkaline than the tank mix acidity; and/or
b2) the base is added.

For example, a) the pesticide formulation (e.g. auxin herbicide formulation) is more acidic than the tank mix acidity, and b1) the water is more alkaline than the tank mix acidity, and optionally b2) the base is added.

In another example, a) the pesticide formulation (e.g. auxin herbicide formulation) is more acidic than the tank mix acidity, and b1) the auxiliary is more alkaline than the tank mix acidity, and optionally b2) the base is added.

In another example, a) the water is more acidic than the tank mix acidity, and b1) the auxiliary is more alkaline than the tank mix acidity, and optionally b2) the base is added.

In another example, a) the water is more acidic than the tank mix acidity, and b1) the pesticide formulation (e.g. auxin herbicide formulation) is more alkaline than the tank mix acidity, and optionally b2) the base is added.

In an even more preferred form of step A)
a) at least one of the components selected from the pesticide formulation (e.g. auxin herbicide formulation), the water, and/or the auxiliary is more acidic than the tank mix acidity; as well as
b2) the base is added.

Typically, the base contains at least one organic amine and/or an inorganic base. In a preferred form, the base contains an organic amine. In another preferred form, the base contains an inorganic base.

Examples for organic amines are monoamines, oligoamines, polyamines, or mixtures thereof. In a preferred form the base comprises a monoamine. In another preferred form the base comprises a oligoamine. In another preferred form the base comprises a polyamine.

Monoamines are compounds which comprise only one primary, secondary or tertiary amine group. Examples are triethanolamine.

In a preferred form monoamines are alkoxylated alkylamines, such as linear or branched C₆₋₃₀ alkylamines, which are ethoxylated and/or propoxylated. Examples are tallow amine ethoxylated, 2-propylheptylamine ethoxylate, iso-C₉-alkylamine ethoxylate. Further examples are those listed in WO 2011/019652 (Monsanto), paragraph [0068] to [0084].

Oligoamines are compounds which comprise from two to nine primary, secondary and/or tertiary amine groups. Examples are ethylenediamine.

In an embodiment the oligoamine has the formula

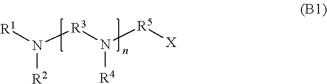

wherein R¹, R², R⁴, R⁶, R⁷ are independently H or C₁-C₆-alkyl, which is optionally substituted with OH, R³ and R⁵ are independently C₂-C₁₀-alkylene, X is OH or NR⁶R⁷, and n is from 1 to 7. R¹, R², R⁴, R⁶ and R⁷ are preferably independently H or methyl. Preferably, R¹, R², R⁶ and R⁷ are H. R⁶ and R⁷ are preferably identical to R¹ and R², respectively. R³ and R⁵ are preferably independently C₂-C₃-alkylene, such as ethylene (—CH₂CH₂—), or n-propylene (—CH₂CH₂CH₂—). Typically, R³ and R⁵ are identical. R³ and R⁵ may be linear or branched, unsubstituted or substituted with halogen. Preferably, R³ and R⁵ are linear. Preferably, R³ and R⁵ are unsubstituted. X is preferably NR⁶R⁷. Preferably, n is from 1 to 5, more preferably from 1 to 4, especially from 1 to 3 Preferably, R¹, R², and R⁴ are independently H or methyl, R³ and R⁵ are independently C₂-C₃-alkylene, X is OH or NR⁶R⁷, and n is from 1 to 10.

The group X is bound to R⁵, which is a C₂-C₁₀-alkylene group. This means that X may be bound to any carbon atom of the C₂-C₁₀-alkylene group. Examples of a unit —R⁵—X are —CH₂—CH₂—CH₂—OH or —CH₂—CH(OH)—CH₃.

R¹, R², R⁴, R⁶, R⁷ are independently H or C₁-C₆-alkyl, which is optionally substituted with OH. Preferably, R¹, R², R⁴, R⁶, R⁷ are independently H or C₁-C₆-alkyl.

In another embodiment the oligoamine has the formula

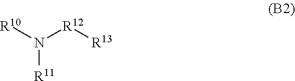

wherein R¹⁰ and R¹¹ are independently H or C₁-C₆-alkyl, R¹² is C₂-C₁₂-alkylene, and R¹³ is an aliphatic C₅-C₈ ring system, which comprises either nitrogen in the ring or which is substituted with at least one unit NR¹⁰R¹¹.

R¹⁰ and R¹¹ are preferably independently H or methyl, more preferably H. Typically R¹⁰ and R¹¹ are linear or branched, unsubstituted or substituted with halogen. Preferably, R¹⁰ and R¹¹ are unsubstituted and linear. More preferably, R¹⁰ and R¹¹ are identical.

R¹² is preferably C₂-C₄-alkylene, such as ethylene (—CH₂CH₂—), or n-propylene (—CH₂CH₂CH₂—). R¹² may be linear or branched, preferably it is linear. R¹² may be unsubstituted or substituted with halogen, preferably it is unsubstituted.

R¹³ is an aliphatic C₅-C₈ ring system, which comprises either nitrogen in the ring or which is substituted with at least one unit NR¹⁰R¹¹. Preferably, R¹³ is an aliphatic C₅-C₈ ring system, which comprises nitrogen in the ring. The C₅-C₈ ring system may be unsubstituted or substituted with at least one C₁-C₆ alkyl group or at least one halogen. Preferably, the C₅-C₈ ring system is unsubstituted or substituted with at least one C₁-C₄ alkyl group. Examples for an aliphatic C₅-C₈ ring system, which comprises nitrogen in the ring, are piperazyl groups.

More preferably, R¹⁰ and R¹¹ are independently H or methyl, R¹² is C₂-C₃-alkylene, and R¹³ is an aliphatic C₅-C₈ ring system, which comprises oxygen or nitrogen in the ring. In another preferred embodiment the cationic polymer of the formula (B2) is free of ether groups (—O—).

In one preferred form oligoamines are oligoamine which are chelating bases. Suitable chelating bases ethylenediaminetetraacetic acid (EDTA), methylglycine diacetic acid (MGA), ethylene glycol tetraacetic acid (EGTA), 1,2-bis(o-aminophenoxy)ethane-N,N,N′,N′-tetraacetic acid (BAPTA).

Polyamines are compounds which comprise at least ten primary, secondary and/or tertiary amine groups. Suitable polyamines are those listed in WO 2011/019652 (Monsanto), paragraph [0045] to [0064].

Examples for inorganic bases are a carbonate, a phosphate, a hydroxide, a silicate, a borate, an oxide, or mixtures thereof. In a preferred form the base comprises a carbonate. In another preferred form the base comprises a phosphate. In another preferred form the base comprises a hydroxide. In another preferred form the base comprises an oxide. In another preferred form the base comprises a borate. In another preferred form the base comprises a silicate.

Suitable carbonates are alkaline or earth alkaline salts of CO₃⁻ or of HCO₃⁻ (Hydrogencarbonates). Alkali salts refer to salts containing preferably sodium and/or potassium as cations.

Preferred carbonates are sodium carbonate or potassium carbonate, wherein the latter is preferred.

In another preferred form carbonates are alkali salts of CO₃²⁻ or of HCO₃⁻. Especially preferred carbonates are selected from sodium carbonate, sodium hydrogencarbonate, potassium carbonate, potassium hydrogencarbonate, and mixtures thereof.

Mixtures of carbonates are also possible. Preferred mixtures of carbonates comprise alkali salts of CO₃²⁻ and alkali salts of HCO₃⁻. Especially preferred mixtures of carbonates comprise potassium carbonate and potassium hydrogencarbonate; or sodium carbonate and sodium hydrogencarbonate. The weight ratio of alkali salts of CO₃²⁻ (e.g. K₂CO₃) to alkali salts of HCO₃⁻ (e.g. KHCO₃) may be in the range of 1:20 to 20:1, preferably 1:10 to 10:1. In another form, the weight ratio of alkali salts of CO₃²⁻ (e.g. K₂CO₃) to alkali salts of HCO₃⁻ (e.g. KHCO₃) may be in the range of 1:1 to 1:25, preferably of 1:2 to 1:18, and in particular of 1:4 to 1:14.

Suitable phosphates are alkaline or earth alkaline salts of secondary or tertiary phosphates, pyrrophosphates, and oligophosphates. Potassium salts of phosphates are preferred, such as Na₃PO₄, Na₂HPO₄, and NaH₂PO₄, and mixtures thereof.

Suitable hydroxides are alkaline, earth alkaline, or organic salts of hydroxides. Preferred hydroxides are NaOH, KOH and choline hydroxide, wherein KOH and choline hydroxide are preferred.

Suitable silicates are alkaline or earth alkaline silicates, such as potassium silicates.

Suitable borates are alkaline or earth alkaline borates, such as potassium, sodium or calcium borates. Fertilizers containing borates are also suitable.

Suitable oxides are alkaline or earth alkaline oxides, such as calcium oxide or magnesium oxide. In a preferred form oxides are used together with chelating bases.

In a more preferred form the base is selected from a carbonate, a phosphate, or a mixture thereof. Preferably, the base is selected from an alkali salt of a carbonate, an alkali salt of hydrogencarbonate, or mixtures thereof. The carbonate and the phosphate may be present in any crystal modification, in pure form, as technical quality, or as hydrates (e.g. K₂CO₃×1.5H₂O).

The base may be present in dispersed or dissolved form, wherein the dissolved form is preferred.

The base has preferably has a solubility in water of at least 1 g/l at 20° C., more preferably of at least 10 g/l, and in particular at least 100 g/l.

Usually, the amount of the base depends on the desired pH value. First, the desired pH may be selected and then the required amount of base is added while controlling the pH value of the tank mix.

The tank mix may contain from 0.4 to 200 g/l, preferably from 0.8 to 100 g/l, and in particular from 2 to 50 g/l of the base.

The molar ratio of the base to the pesticide may be from 30:1 to 1:10, preferably from 10:1 to 1:5, and in particular from 5:1 to 1:1. For calculation of the molar ratio, the sum of all bases (e.g. CO₃²⁻ and HCO₃⁻) except the further base may be applied. For calculation of the molar ratio, the sum of all pesticides (preferably of all anionic pesticides) may be applied.

The tank mix may comprise further bases, such as an organic amine and/or an inorganic base, which is different from the base. In a preferred form the tank mix comprises up to 40 mol %, preferably up to 15 mol %, and in particular up to 3 mol % further bases, based on the total amount of the base selected from a carbonate and/or a phosphate. In another form the tank mix is essentially free of further bases. The further base may be present in dispersed or dissolved form in the tank mix, wherein the dissolved form is preferred. The further base have preferably has a solubility in water of at least 1 g/l at 20° C., more preferably of at least 10 g/l, and in particular at least 100 g/l.

The base may be applied in form of a tank mix adjuvant. The tank mix adjuvant may be present in form of an aqueous liquid or a particulate solid.

In one form the tank mix adjuvant is present in form of an aqueous liquid (e.g. at 20° C.), which contains at least 200 g/l, preferably at least 300 g/l, and in particular at least 400 g/l of the base. The aqueous liquid may contain at least 5 wt %, preferably at least 15 wt %, and in particular at least 30 wt % water. The aqueous liquid may contain up to 80 wt %, preferably up to 65 wt %, and in particular up to 50 wt % water.

The aqueous liquid may have a pH value of at least 8.0, preferably at least 8.5, more preferably at least 9.0, even more preferably at least 9.5, in particular at least 10.0, even more particular at least 11.0. The aqueous liquid may have a pH value of up to 14.0, preferably up to 13.0, and in particular up to 12.0. The aqueous liquid may have a pH value in the range of 8.0 to 14.0, preferably of 8.0 to 13.0, and in particular form 8.5 to 12.5.

The aqueous liquid may comprise auxiliaries, such as those listed below. Preferably, the aqueous liquid comprises auxiliaries such as anti-freezing agents (e.g. glycerin), anti-foaming agents, (e.g. silicones), crystallization inhibitors (e.g. salts of polyacrylic acid), anti-drift agents or binders. The aqueous liquid may comprise up to 15 wt %, preferably up to 10 wt %, and in particular up to 5 wt % auxiliaries.

In a preferred form the aqueous liquid contains at least 200 g/l of the base (such as an alkali salt of CO₃²⁻ and/or an alkali salt of HCO₃⁻), up to 15 wt % of auxiliaries (e.g. anti-drift agent and crystallization inhibitors (e.g. salts of polyacrylic acid)), and has a pH value of at least 8.0.

In a preferred form the aqueous liquid contains at least 250 g/l of the base (such as an alkali salt of CO₃²⁻ and/or an alkali salt of HCO₃⁻), up to 10 wt % of auxiliaries (e.g. anti-drift agent and crystallization inhibitors (e.g. salts of polyacrylic acid)), and has a pH value of at least 8.5.

In another form the tank mix adjuvant is present in form of a particulate solid (e.g. at 20° C.), which contains at least 50 wt %, preferably at least 80 wt %, and in particular at least 90 wt % of the base.

The particulate solid may have a particle size D₉₀ of up to 100 mm, preferably up to 10 mm, and in particular up to 5 mm. The particle size may be determined by sieving.

The particulate solid may contain less than 1 wt % dust. Dust means typically particles, which have a particle size of below 50 μm.

The particulate solid may be soluble in water (e.g. in the tank mix) in an amount of at least 0.5 wt %, preferably at least 5 wt %, and in particular at least 20 wt %.

The particulate solid may a pH value (10 wt % in water) of at least 8.0, preferably at least 8.5, more preferably at least 9.0, even more preferably at least 9.5, in particular at least 10.0, even more particular at least 11.0.

The particulate solid may comprise auxiliaries, such as those listed below. Preferably, the particulate solid comprises auxiliaries such as anti-foaming agents (e.g. silicones), binders, anti-drift agents, crystallization inhibitors (e.g. salts of polyacrylic acid), or separating agents. The particulate solid may comprise up to 15 wt %, preferably up to 10 wt %, and in particular up to 5 wt % auxiliaries.

Suitable separating agents are kaolinite, aluminum silicate, aluminum hydroxide, calcium carbonate, magnesium carbonate. The particulate solid may contain up to 5 wt %, preferably up to 2 wt % of the separating agent.

In a preferred form the particulate solid contains at least 80 wt % of the base (such as an alkali salt of CO₃²⁻ and/or an alkali salt of HCO₃⁻), up to 10 wt % auxiliaries (e.g. a separating agent), and has a particle size D₉₀ of up to 10 mm.

In a more preferred form the particulate solid contains at least 90 wt % of the base (such as an alkali salts of CO₃²⁻ and/or an alkali salts of HCO₃⁻), up to 5 wt % auxiliaries (e.g. a separating agent), and has a particle size D₉₀ of up to 10 mm.

The tank mix may be free of cationic compounds, which can dissociate into a proton and an amine, and which have a low vapor pressure (e.g. organic amines like dimethyl amine, isopropylamine, ethanol amine). The vapor pressure at 20° C. is usually up to 10 mbar, preferably up to 1 mbar, more preferably up to 0.1 mbar and in particular up to 0.01 mbar. Usually, the tank mix comprises less than 1 wt %, preferably less than 0.1%, and more preferably less than 0.01 wt % cationic compounds, which can dissociate into a proton and an amine and which have a low vapor pressure. In particular, the tank mix is free of cationic compounds, which can dissociate into a proton and an amine and which have a low vapor pressure.

The tank mix may be free of cationic compounds, which can dissociate into a proton and an amine, and which have a low boiling point (e.g. organic amines like dimethyl amine, isopropylamine, ethanol amine). The boiling point (or where applicable the onset of boiling) at 1013 mbar is usually up to 150° C., preferably up to 200° C., and in particular up to 250° C. Usually, the tank mix comprises less than 1 wt %, preferably less than 0.1%, and more preferably less than 0.01 wt % cationic compounds, which can dissociate into a proton and an amine and which have a low boiling point. In particular, the tank mix is free of cationic compounds, which can dissociate into a proton and an amine and which have a low boiling point.

The tank mix may be free of cationic compounds, which can dissociate into a proton and an amine, and which have a low flash point (e.g. organic amines like dimethyl amine, isopropylamine, ethanol amine). The flash point (may be determined according to DIN51758) is usually up to 100° C., preferably up to 130° C., and in particular up to 150° C. Usually, the tank mix comprises less than 1 wt %, preferably less than 0.1%, and more preferably less than 0.01 wt % cationic compounds, which can dissociate into a proton and an amine and which have a low flash point. In particular, the tank mix is free of cationic compounds, which can dissociate into a proton and an amine and which have a low flash point.

Pesticide formulations (e.g. auxin herbicide formulation) are generally known and commercially available. Pesticide formulations usually comprise a pesticide and an auxiliary. They may be any type of agrochemical formulation, such as solid or liquid formulations. Examples for composition types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), solutions (e.g. SL). Further examples for compositions types are listed in the “Catalogue of pesticide formulation types and international coding system”, Technical Monograph No 2, 6^{th} Ed. May 2008, CropLife International. Preferably, the pesticide formulation (e.g. auxin herbicide formulation) is an aqueous liquid formulation, such as an SL formulation. The pesticide formulation (e.g. auxin herbicide formulation) may contain at least 10 wt % auxin herbicide, preferably at least 15 wt %, and in particular at least 20 wt %. In another form, the pesticide formulation (e.g. auxin herbicide formulation) may contain at least 10 wt % of any pesticides, preferably at least 20 wt %, and in particular at least 30 wt %.

Various synthetic and natural auxin herbicides are known, wherein synthetic auxin herbicides are preferred. Preferably, the auxin herbicide comprises a protonizable hydrogen. More preferably, auxin herbicides relate to pesticides comprising a carboxylic, thiocarbonic, sulfonic, sulfinic, thiosulfonic or phosphorous acid group, especially a carboxylic acid group. The aforementioned groups may be partly present in neutral form including the protonizable hydrogen.

Examples for natural auxin herbicides are indole-3acetic acid (IAA), phenyl acetic acid (PAA), 4-chloroindole-3-acetic acid (4-Cl-IAA), and indole-3-butanoic acid (IBA).

Examples for synthetic auxin herbicides are 2,4-D and its salts, 2,4-DB and its salts, aminopyralid and its salts such as aminopyralid-tris(2-hydroxypropyl)ammonium, benazolin, chloramben and its salts, clomeprop, clopyralid and its salts, dicamba and its, dichlorprop and its salts, dichlorprop-P and its salts, fluroxypyr, MCPA and its salts, MCPA-thioethyl, MCPB and its salts, mecoprop and its salts, mecoprop-P and its salts, picloram and its salts, quinclorac, quinmerac, TBA (2,3,6) and its salts, triclopyr and its salts, and aminocyclopyrachlor and its salts.

Preferred auxin herbicides are 2,4-D and its salts, and dicamba and its salts, wherein dicamba is more preferred. In another more preferred form, the auxin herbicide contains an alkali metal salt of dicamba, such as sodium and/or potassium.

Mixtures of the aforementioned auxin herbicides are also possible.

The pesticide (e.g. auxin herbicide) may be dissolved or dispersed in the tank mix. Preferably, the pesticide (e.g. auxin herbicide is dissolved in the tank mix.

The pesticide (e.g. auxin herbicide) has often a solubility in water at 20° C. of at least 10 g/l, preferably of at least 50 g/l, and in particular of at least 100 g/l.

The tank mix may comprise further pesticides (e.g. one or two further pesticides) beside the auxin herbicide or beside the pesticide (i.e. the tank mix may comprise more than one pesticide). The further pesticides may be selected from the following list of pesticides.

The term “pesticide” within the meaning of the invention states that one or more compounds can be selected from the group consisting of fungicides, insecticides, nematicides, herbicide and/or safener or growth regulator, preferably from the group consisting of fungicides, insecticides or herbicides, most preferably from the group consisting of herbicides. Also mixtures of pesticides of two or more the aforementioned classes can be used. The skilled artisan is familiar with such pesticides, which can be, for example, found in the Pesticide Manual, 15th Ed. (2009), The British Crop Protection Council, London.

Examples for fungicides are:

### A) Strobilurins

azoxystrobin, dimoxystrobin, enestroburin, fluoxastrobin, kresoxim-methyl, metominostrobin, orysastrobin, picoxystrobin, pyraclostrobin, pyrametostrobin, pyraoxystrobin, pyribencarb, trifloxystrobin, methyl (2-chloro-5-[1-(3-methylbenzyloxyimino)ethyl]benzyl)carbamate and 2-(2-(3-(2,6-dichlorophenyl)-1-methyl-allylideneaminooxymethyl)-phenyl)-2-methoxyimino-N-methyl-acetamide;

### B) Carboxamides

carboxanilides: benalaxyl, benalaxyl-M, benodanil, bixafen, boscalid, carboxin, fenfuram, fenhexamid, flutolanil, furametpyr, isopyrazam, isotianil, kiralaxyl, mepronil, metalaxyl, metalaxyl-M (mefenoxam), ofurace, oxadixyl, oxycarboxin, penflufen, penthiopyrad, sedaxane, tecloftalam, thifluzamide, tiadinil, 2-amino-4-methyl-thiazole-5-carboxanilide, N-(3′,4′,5′-trifluorobiphenyl-2-yl)-3-difluoromethyl-1-methyl-1H-pyrazole-4-carboxamide, N-(4′-trifluoro-methylthiobiphenyl-2-yl)-3-difluoromethyl-1-methyl-1H-pyrazole-4-carboxamide and N-(2-(1,3,3-trimethyl-butyl)-phenyl)-1,3-dimethyl-5-fluoro-1H-pyrazole-4-carboxamide;
carboxylic morpholides: dimethomorph, flumorph, pyrimorph;
benzoic acid amides: flumetover, fluopicolide, fluopyram, zoxamide;
other carboxamides: carpropamid, dicyclomet, mandiproamid, oxytetracyclin, silthiofarm and N-(6-methoxy-pyridin-3-yl) cyclopropanecarboxylic acid amide;

### C) Azoles

triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole;
imidazoles: cyazofamid, imazalil, pefurazoate, prochloraz, triflumizol;
benzimidazoles: benomyl, carbendazim, fuberidazole, thiabendazole;
others: ethaboxam, etridiazole, hymexazole and 2-(4-chloro-phenyl)-N-[4-(3,4-dimethoxyphenyl)-isoxazol-5-yl]-2-prop-2-ynyloxy-acetamide;

### D) Heterocyclic Compounds

pyridines: fluazinam, pyrifenox, 3-[5-(4-chloro-phenyl)-2,3-dimethyl-isoxazolidin-3-yl]-pyridine, 3-[5-(4-methyl-phenyl)-2,3-dimethyl-isoxazolidin-3-yl]-pyridine;
pyrimidines: bupirimate, cyprodinil, diflumetorim, fenarimol, ferimzone, mepanipyrim, nitrapyrin, nuarimol, pyrimethanil;
piperazines: triforine;
pyrroles: fenpiclonil, fludioxonil;
morpholines: aldimorph, dodemorph, dodemorph-acetate, fenpropimorph, tridemorph;
piperidines: fenpropidin;
dicarboximides: fluoroimid, iprodione, procymidone, vinclozolin;
non-aromatic 5-membered heterocycles: famoxadone, fenamidone, flutianil, octhilinone, probenazole, 5-amino-2-isopropyl-3-oxo-4-ortho-tolyl-2,3-dihydro-pyrazole-1-carbothioic acid S-allyl ester;
others: acibenzolar-S-methyl, ametoctradin, amisulbrom, anilazin, blasticidin-S, captafol, captan, chinomethionat, dazomet, debacarb, diclomezine, difenzoquat, difenzoquat-methylsulfate, fenoxanil, Folpet, oxolinic acid, piperalin, proquinazid, pyroquilon, quinoxyfen, triazoxide, tricyclazole, 2-butoxy-6-iodo-3-propylchromen-4-one, 5-chloro-1-(4,6-dimethoxy-pyrimidin-2-yl)-2-methyl-1H-benzoimidazole and 5-chloro-7-(4-methylpiperidin-1-yl)-6-(2,4,6-trifluorophenyl)-[1,2,4]triazolo[1,5-a]pyrimidine;

### E) Carbamates

thio- and dithiocarbamates: ferbam, mancozeb, maneb, metam, methasulphocarb, metiram, propineb, thiram, zineb, ziram;
carbamates: benthiavalicarb, diethofencarb, iprovalicarb, propamocarb, propamocarb hydrochlorid, valifenalate and N-(1-(1-(4-cyano-phenyl)ethanesulfonyl)-but-2-yl) carbamic acid-(4-fluorophenyl) ester;

### F) Other Active Substances

guanidines: guanidine, dodine, dodine free base, guazatine, guazatine-acetate, iminoctadine, iminoctadine-triacetate, iminoctadine-tris(albesilate);
antibiotics: kasugamycin, kasugamycin hydrochloride-hydrate, streptomycin, polyoxine, validamycin A;
nitrophenyl derivates: binapacryl, dinobuton, dinocap, nitrthal-isopropyl, tecnazen, organometal compounds: fentin salts, such as fentin-acetate, fentin chloride or fentin hydroxide;
sulfur-containing heterocyclyl compounds: dithianon, isoprothiolane;
organophosphorus compounds: edifenphos, fosetyl, fosetyl-aluminum, iprobenfos, phosphorous acid and its salts, pyrazophos, tolclofos-methyl;
organochlorine compounds: chlorothalonil, dichlofluanid, dichlorophen, flusulfamide, hexachlorobenzene, pencycuron, pentachlorphenole and its salts, phthalide, quintozene, thiophanate-methyl, tolylfluanid, N-(4-chloro-2-nitro-phenyl)-N-ethyl-4-methylbenzenesulfonamide;
inorganic active substances: Bordeaux mixture, copper acetate, copper hydroxide, copper oxychloride, basic copper sulfate, sulfur;
others: biphenyl, bronopol, cyflufenamid, cymoxanil, diphenylamin, metrafenone, mildiomycin, oxin-copper, prohexadione-calcium, spiroxamine, tebufloquin, tolylfluanid, N-(cyclopropylmethoxyimino-(6-difluoro-methoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2-methyl-4-(3-trimethylsilanyl-propoxy)phenyl)-N-ethyl-N-methyl formamidine,
2-{1-[2-(5-methyl-3-trifluoromethyl-pyrazole-1-yl)-acetyl]-piperidin-4-yl}-thiazole-4-carboxylic acid methyl-(1,2,3,4-tetrahydro-naphthalen-1-yl)-amide, 2-{1-[2-(5-methyl-3-trifluoromethyl-pyrazole-1-yl)-acetyl]piperidin-4-yl}-thiazole-4-carboxylic acid methyl-(R)-1,2,3,4-tetrahydronaphthalen-1-yl-amide, methoxy-acetic acid 6-tert-butyl-8-fluoro-2,3-dimethyl-quinolin-4-yl ester and N-Methyl-2-{1-[(5-methyl-3-trifluoromethyl-1H-pyrazol-1-yl)-acetyl]-piperidin-4-yl}-N-[(1R)-1,2,3,4-tetrahydronaphthalen-1-yl]-4-thiazolecarboxamide.

Examples for growth regulators are:

Abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N-6-benzyladenine, paclobutrazol, prohexadione (prohexadione-calcium), prohydrojasmon, thidiazuron, triapenthenol, tributyl phosphorotrithioate, 2,3,5-tri-iodobenzoic acid, trinexapac-ethyl and uniconazole.

Examples for herbicides are:
acetamides: acetochlor, alachlor, butachlor, dimethachlor, dimethenamid, flufenacet, mefenacet, metolachlor, metazachlor, napropamide, naproanilide, pethoxamid, pretilachlor, propachlor, thenylchlor;
amino acid derivatives: bilanafos, glyphosate (e.g. glyphosate free acid, glyphosate ammonium salt, glyphosate isopropylammonium salt, glyphosate trimethylsulfonium salt, glyphosate potassium salt, glyphosate dimethylamine salt), glufosinate, sulfosate;
aryloxyphenoxypropionates: clodinafop, cyhalofop-butyl, fenoxaprop, fluazifop, haloxyfop, metamifop, propaquizafop, quizalofop, quizalofop-P-tefuryl;
Bipyridyls: diquat, paraquat;
(thio)carbamates: asulam, butylate, carbetamide, desmedipham, dimepiperate, eptam (EPTC), esprocarb, molinate, orbencarb, phenmedipham, prosulfocarb, pyributicarb, thiobencarb, triallate;
cyclohexanediones: butroxydim, clethodim, cycloxydim, profoxydim, sethoxydim, tepraloxydim, tralkoxydim;
dinitroanilines: benfluralin, ethalfluralin, oryzalin, pendimethalin, prodiamine, trifluralin;
diphenyl ethers: acifluorfen, aclonifen, bifenox, diclofop, ethoxyfen, fomesafen, lactofen, oxyfluorfen;
hydroxybenzonitriles: bomoxynil, dichlobenil, ioxynil;
imidazolinones: imazamethabenz, imazamox, imazapic, imazapyr, imazaquin, imazethapyr;
phenoxy acetic acids: clomeprop, 2,4-dichlorophenoxyacetic acid (2,4-D), 2,4-DB, dichlorprop, MCPA, MCPA-thioethyl, MCPB, Mecoprop;
pyrazines: chloridazon, flufenpyr-ethyl, fluthiacet, norflurazon, pyridate;
pyridines: aminopyralid, clopyralid, diflufenican, dithiopyr, fluridone, fluroxypyr, picloram, picolinafen, thiazopyr;
sulfonyl ureas: amidosulfuron, azimsulfuron, bensulfuron, chlorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metazosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, 1-((2-chloro-6-propyl-imidazo[1,2-b]pyridazin-3-yl)sulfonyl)-3-(4,6-dimethoxy-pyrimidin-2-yl)urea;
triazines: ametryn, atrazine, cyanazine, dimethametryn, ethiozin, hexazinone, metamitron, metribuzin, prometryn, simazine, terbuthylazine, terbutryn, triaziflam;
ureas: chlorotoluron, daimuron, diuron, fluometuron, isoproturon, linuron, methabenzthiazuron, tebuthiuron;
other acetolactate synthase inhibitors: bispyribac-sodium, cloransulam-methyl, diclosulam, florasulam, flucarbazone, flumetsulam, metosulam, ortho-sulfamuron, penoxsulam, propoxycarbazone, pyribambenz-propyl, pyribenzoxim, pyriftalid, pyriminobac-methyl, pyrimisulfan, pyrithiobac, pyroxasulfone, pyroxsulam;
others: amicarbazone, aminotriazole, anilofos, beflubutamid, benazolin, bencarbazone, benfluresate, benzofenap, bentazone, benzobicyclon, bicyclopyrone, bromacil, bromobutide, butafenacil, butamifos, cafenstrole, carfentrazone, cinidon-ethlyl, chlorthal, cinmethylin, clomazone, cumyluron, cyprosulfamide, dicamba, difenzoquat, diflufenzopyr, Drechslera monoceras, endothal, ethofumesate, etobenzanid, fenoxasulfone, fentrazamide, flumiclorac-pentyl, flumioxazin, flupoxam, flurochloridone, flurtamone, indanofan, isoxaben, isoxaflutole, lenacil, propanil, propyzamide, quinclorac, quinmerac, mesotrione, methyl arsonic acid, naptalam, oxadiargyl, oxadiazon, oxaziclomefone, pentoxazone, pinoxaden, pyraclonil, pyraflufen-ethyl, pyrasulfotole, pyrazoxyfen, pyrazolynate, quinoclamine, saflufenacil, sulcotrione, sulfentrazone, terbacil, tefuryltrione, tembotrione, thiencarbazone, topramezone, (3-[2-chloro-4-fluoro-5-(3-methyl-2,6-dioxo-4-trifluoromethyl-3,6-dihydro-2H-pyrimidin-1-yl)-phenoxy]-pyridin-2-yloxy)-acetic acid ethyl ester, 6-amino-5-chloro-2-cyclopropyl-pyrimidine-4-carboxylic acid methyl ester, 6-chloro-3-(2-cyclopropyl-6-methylphenoxy)-pyridazin-4-ol, 4-amino-3-chloro-6-(4-chloro-phenyl)-5-fluoro-pyridine-2-carboxylic acid, 4-amino-3-chloro-6-(4-chloro-2-fluoro-3-methoxy-phenyl)-pyridine-2-carboxylic acid methyl ester, and 4-amino-3-chloro-6-(4-chloro-3-dimethylamino-2-fluoro-phenyl)-pyridine-2-carboxylic acid methyl ester.

Examples for insecticides are:
organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methylparathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin;
insect growth regulators: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramat;
nicotinic receptor agonists/antagonists compounds: clothianidin, dinotefuran, imidacloprid, thiamethoxam, nitenpyram, acetamiprid, thiacloprid, 1-(2-chloro-thiazol-5-ylmethyl)-2-nitrimino-3,5-dimethyl-[1,3,5]triazinane;
GABA antagonist compounds: endosulfan, ethiprole, fipronil, vaniliprole, pyrafluprole, pyriprole, 5-amino-1-(2,6-dichloro-4-methyl-phenyl)-4-sulfinamoyl-1H-pyrazole-3-carbothioic acid amide;
macrocyclic lactone insecticides: abamectin, emamectin, milbemectin, lepimectin, spinosad, spinetoram;
mitochondrial electron transport inhibitor (METI) I acaricides: fenazaquin, pyridaben, tebufenpyrad, tolfenpyrad, flufenerim;
METI II and III compounds: acequinocyl, fluacyprim, hydramethylnon;
Uncouplers: chlorfenapyr;
oxidative phosphorylation inhibitors: cyhexatin, diafenthiuron, fenbutatin oxide, propargite;
moulting disruptor compounds: cryomazine;
mixed function oxidase inhibitors: piperonyl butoxide;
sodium channel blockers: indoxacarb, metaflumizone;
others: benclothiaz, bifenazate, cartap, flonicamid, pyridalyl, pymetrozine, sulfur, thiocyclam, flubendiamide, chlorantraniliprole, cyazypyr (HGW86), cyenopyrafen, flupyrazofos, cyflumetofen, amidoflumet, imicyafos, bistrifluron, and pyrifluquinazon.

The pesticide and the further pesticide have often a solubility in water at 20° C. of at least 10 g/l, preferably of at least 50 g/l, and in particular of at least 100 g/l.

The pesticide may be dissolved or dispersed in the tank mix. Preferably, the pesticide is dissolved in the tank mix.

Preferred further pesticides are herbicides, such as organophosphorus herbicides comprising a carboxylic acid group. The term “organophosphorous herbicides” usually refers to herbicides containing a phosphinic or phosphorous acid group. Suitable organophosphorous herbicides comprising a carboxylic acid group are bialafos, glufosinate, glufosinate-P, glyphosate.

Especially preferred further pesticides are bilanafos, glufosinate, glufosinate-P, glyphosate, and one or more pesticides from the class of imidazolinones. In particular preferred is glyphosate. In another particular preferred form, the further pesticide contains an alkali metal salt of glyphosate, such as sodium and/or potassium glyphosate.

In a preferred form, the auxin herbicide contains an alkali metal salt of dicamba (such as sodium and/or potassium) and a further pesticide, which contains an alkali metal salt of glyphosate (such as sodium and/or potassium glyphosate). The alkali metal salts of glyphosate may contain from one to three (e.g. one, two or three) alkali metal ions, or a mixture thereof. Preferably, the alkali metal salts of glyphosate contains at least 2 equivalents (in particular two or three equivalents, or a mixture thereof) of alkali metal ions per glyphosate ion. Examples are monosodium glyphosate, monopotassium glyphosate, disodium glyphosate, trisodium glyphosate, dipotassium glyphosate, tripotassium glyphosate, or mixtures thereof. Preferred are disodium glyphosate, trisodium glyphosate, dipotassium glyphosate, tripotassium glyphosate, or mixtures thereof (e.g. a mixture of disodium glyphosate and trisodium glyphosate; or of dipotassium glyphosate and tripotassium glyphosate; or of dipotassium glyphosate, trisodium glyphosate; or of disodium glyphosate and tripotassium glyphosate).

In another preferred form the pesticide comprises a growth regulator, such as prohexadione (especially prohexadione calcium).

In another preferred form the pesticide comprises an auxin herbicide and/or an organophosphorous herbicide.

In another preferred form the pesticide contains a anionic pesticide. The term “anionic pesticide” refers to a pesticide, which is present as an anion. Preferably, anionic pesticides relate to pesticides comprising a protonizable hydrogen. More preferably, anionic pesticides relate to pesticides comprising a carboxylic, thiocarbonic, sulfonic, sulfinic, thiosulfonic, phosphinic, or phosphorous acid group, especially a carboxylic acid group. The aforementioned groups may be partly present in neutral form including the protonizable hydrogen.

Usually, anions such as anionic pesticides comprise at least one anionic group. Preferably, the anionic pesticide comprises one or two anionic groups. In particular the anionic pesticide comprises exactly one anionic group. An example of an anionic group is a carboxylate group (—C(O)O⁻). The aforementioned anionic groups may be partly present in neutral form including the protonizable hydrogen. For example, the carboxylate group may be present partly in neutral form of carboxylic acid (—C(O)OH). This is preferably the case in aqueous compositions, in which an equilibrium of carboxylate and carboxylic acid may be present.

Suitable anionic pesticides are given in the following. In case the names refer to a neutral form or a salt of the anionic pesticide, the anionic form of the anionic pesticides are meant. For example, the anionic form of dicamba may be represented by the following formula:

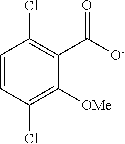 [SMILES: COc1c(Cl)ccc(Cl)c1C(=O)[O-]]

As another example, the anionic form of glyphosate may be a contain one, two, three, or a mixture thereof, negative charges.

It is known to an expert, that the dissociation of the functional groups and thus the location of the anionic charge may depend for example on the pH, when the anionic pesticides is present in dissolved form. The acid dissociation constants pKₐ of glyphosate are typically 0.8 for the first phosphonic acid, 2.3 for the carboxylic acid, 6.0 for the second phosphonic acid, and 11.0 for the amine.

Suitable anionic pesticides are herbicides, which comprise a carboxylic, thiocarbonic, sulfonic, sulfinic, thiosulfonic or phosphorous acid group, especially a carboxylic acid group. Examples are aromatic acid herbicides, phenoxycarboxylic acid herbicides or organophosphorous herbicides comprising a carboxylic acid group.

Suitable aromatic acid herbicides are benzoic acid herbicides, such as diflufenzopyr, naptalam, chloramben, dicamba, 2,3,6-trichlorobenzoic acid (2,3,6-TBA), tricamba; pyrimidinyloxybenzoic acid herbicides, such as bispyribac, pyriminobac; pyrimidinylthiobenzoic acid herbicides, such as pyrithiobac; phthalic acid herbicides, such as chlorthal; picolinic acid herbicides, such as aminopyralid, clopyralid, picloram; quinolinecarboxylic acid herbicides, such as quinclorac, quinmerac; or other aromatic acid herbicides, such as aminocyclopyrachlor. Preferred are benzoic acid herbicides, especially dicamba.

Suitable phenoxycarboxylic acid herbicides are phenoxyacetic herbicides, such as 4-chlorophenoxyacetic acid (4-CPA), (2,4-dichlorophenoxy)acetic acid (2,4-D), (3,4-dichlorophenoxy)acetic acid (3,4-DA), MCPA (4-(4-chloro-o-tolyloxy)butyric acid), MCPA-thioethyl, (2,4,5-trichlorophenoxy)acetic acid (2,4,5-T); phenoxybutyric herbicides, such as 4-CPB, 4-(2,4-dichlorophenoxy)butyric acid (2,4-DB), 4-(3,4-dichlorophenoxy)butyric acid (3,4-DB), 4-(4-chloro-o-tolyloxy)butyric acid (MCPB), 4-(2,4,5-trichlorophenoxy)butyric acid (2,4,5-TB); phenoxypropionic herbicides, such as cloprop, 2-(4-chlorophenoxy)propanoic acid (4-CPP), dichlorprop, dichlorprop-P, 4-(3,4-dichlorophenoxy)butyric acid (3,4-DP), fenoprop, mecoprop, mecoprop-P; aryloxyphenoxypropionic herbicides, such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P, trifop. Preferred are phenoxyacetic herbicides, especially 2,4-D.

The term “organophosphorous herbicides” usually refers to herbicides containing a phosphinic or phosphorous acid group. Suitable organophosphorous herbicides comprising a carboxylic acid group are bialafos, glufosinate, glufosinate-P, glyphosate. Preferred is glyphosate.

Suitable other herbicides comprising a carboxylic acid are pyridine herbicides comprising a carboxylic acid, such as fluroxypyr, triclopyr; triazolopyrimidine herbicides comprising a carboxylic acid, such as cloransulam; pyrimidinylsulfonylurea herbicides comprising a carboxylic acid, such as bensulfuron, chlorimuron, foramsulfuron, halosulfuron, mesosulfuron, primisulfuron, sulfometuron; imidazolinone herbicides, such as imazamethabenz, imazamethabenz, imazamox, imazapic, imazapyr, imazaquin and imazethapyr; triazolinone herbicides such as flucarbazone, propoxycarbazone and thiencarbazone; aromatic herbicides such as acifluorfen, bifenox, carfentrazone, flufenpyr, flumiclorac, fluoroglycofen, fluthiacet, lactofen, pyraflufen. Further on, chlorflurenol, dalapon, endothal, flamprop, flamprop-M, flupropanate, flurenol, oleic acid, pelargonic acid, TCA may be mentioned as other herbicides comprising a carboxylic acid.

Suitable anionic pesticides are fungicides, which comprise a carboxylic, thiocarbonic, sulfonic, sulfinic, thiosulfonic or phosphorous acid group, especially a carboxylic acid group. Examples are polyoxin fungicides, such as polyoxorim.

Suitable anionic pesticides are insecticides, which comprise a carboxylic, thiocarbonic, sulfonic, sulfinic, thiosulfonic or phosphorous acid group, especially a carboxylic acid group. Examples are thuringiensin.

Suitable anionic pesticides are plant growth regulator, which comprise a carboxylic, thiocarbonic, sulfonic, sulfinic, thiosulfonic or phosphorous acid group, especially a carboxylic acid group. Examples are 1-naphthylacetic acid, (2-naphthyloxy)acetic acid, indol-3-ylacetic acid, 4-indol-3-ylbutyric acid, glyphosine, jasmonic acid, 2,3,5-triiodobenzoic acid, prohexadione, trinexapac, preferably prohexadione and trinexapac.

Preferred anionic pesticides are anionic herbicides, more preferably dicamba, glyphosate, 2,4-D, aminopyralid, aminocyclopyrachlor and MCPA. Especially preferred are dicamba and glyphosate. In another preferred embodiment, dicamba is preferred. In another preferred embodiment, 2,4-D is preferred. In another preferred embodiment, glyphosate is preferred. In another preferred embodiment, MCPA is preferred.

The tank mix may comprise other cations. Other cations are usually cations, which are different from an alkali metal cation or a hydrogen cation. Examples of other cations are protonated organic amines, such as dimethyl amine, isopropylamine, and/or ethanol amine, each in the protonated form. Usually, the molar excess of alkali metal cations to the other cations is at least 1.2-fold, preferably at least 2-fold, more preferably at least 5-fold, even more preferably at least 20-fold, and in particular at least 100-fold. For example, a molar excess of 1.2-fold means that 1.2 mol/l of the alkali metal cations and 1.0 mol/l of the other cations are present.

The tank mix typically comprise from about 0.1 g a.e./L to about 50 g a.e./L total loading of herbicides. The weight ratio on an acid equivalent basis of the auxin herbicide to the total herbicide is usually not greater than about 50:1, for example, about 50:1, 25:1, 10:1, 5:1, 3:1, 2:1, 1:1, 1:2, 1:3, 1:5 or even about 1:10 and ranges thereof, for example, from about 50:1 to about 1:10, from about 50:1 to about 1:5, from about 50:1 to about 1:1, from about 50:1 to about 3:1, from about 50:1 to about 5:1, from about 50:1 to about 10:1, from about 25:1 to about 1:1, or from about 25:1 to about 3:1, are preferred.

The tank mix may also comprise auxiliaries which are customary in agrochemical compositions. The auxiliaries used depend on the particular application form and active substance, respectively. Examples for suitable auxiliaries are solvents, solid carriers, dispersants or emulsifiers (such as further solubilizers, protective colloids, surfactants and adhesion agents), organic and anorganic thickeners, bactericides, anti-drift agents, crystallization inhibitors, anti-freezing agents or anti-foaming agents. Preferably, the auxiliary comprises a surfactant, an anti-freezing agent, an anti-drift agent, crystallization inhibitors, and/or an anti-foaming agent.

Suitable solvents are water, organic solvents such as mineral oil fractions of medium to high boiling point, such as kerosene or diesel oil, furthermore coal tar oils and oils of vegetable or animal origin, aliphatic, cyclic and aromatic hydrocarbons, e.g. toluene, xylene, paraffin, tetrahydronaphthalene, alkylated naphthalenes or their derivatives, alcohols such as methanol, ethanol, propanol, butanol and cyclohexanol, glycols, ketones such as cyclohexanone and gamma-butyrolactone, fatty acid dimethylamides, fatty acids and fatty acid esters and strongly polar solvents, e.g. amines such as N-methylpyrrolidone. Preferred solvenist water.

Suitable crystallization inhibitors are polyacrylic acids and their salts, whereas the latter are preferred. The salts of polyacrylic acids may be ammonium, primary, secondary or tertiary ammonium derivatives, or alkali metal salts (e.g. sodium, potassium, lithium ions), wherein alkali metal salts such as sodium salts are preferred. The polyacrylic acids and their salts usually have a molecular weight (as determined by GPC, calibration with polystyrene sulphonates) of 1000 Da to 300 kDa, preferably of 1000 Da to 80 kDa, and in particular 1000 Da to 15 kDa. The crystallization inhibitors are usually water-soluble, e.g. at least 1 g/l, preferably at least 10 g/l, and in particular at least 100 g/l at 20° C. The tank mix usually contains from 0.0001 to 0.2 wt %, preferably from 0.005 to 0.05 wt % of the crystallization inhibitors (e.g. salts of polyacrylic acid). The tank mix adjuvant usually contains from 0.1 to 5.0 wt %, preferably from 0.25 to 2.5 wt % of the crystallization inhibitors (e.g. salts of polyacrylic acid).

Suitable surfactants (adjuvants, wetters, tackifiers, dispersants or emulsifiers) are alkali metal, alkaline earth metal and ammonium salts of aromatic sulfonic acids, such as ligninsulfonic acid (Borresperse® types, Borregard, Norway) phenolsulfonic acid, naphthalenesulfonic acid (Morwet® types, Akzo Nobel, U.S.A.), dibutylnaphthalene-sulfonic acid (Nekal® types, BASF, Germany), and fatty acids, alkylsulfonates, alkylarylsulfonates, alkyl sulfates, laurylether sulfates, fatty alcohol sulfates, and sulfated hexa-, hepta- and octadecanolates, sulfated fatty alcohol glycol ethers, furthermore condensates of naphthalene or of naphthalenesulfonic acid with phenol and formaldehyde, polyoxy-ethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and proteins, denatured proteins, polysaccharides (e.g. methylcellulose), hydrophobically modified starches, polyvinyl alcohols (Mowiol® types, Clariant, Switzerland), polycarboxylates (Sokolan® types, BASF, Germany), polyalkoxylates, polyvinylamines (Lupasol® types, BASF, Germany), polyvinylpyrrolidone and the copolymers thereof.

In a preferred form suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable anti-drift agents are for example nonionic polymers (such as polyacrylamides, polyethylene glycols, or guar gum with a molecular weight of at least 20 kDa, preferably at least 50 kDa, and in particular at least 100 kDa. Such products are commercially available under the tradenames Guar DV27 from Rhodia, Companion® Gold, Border® EG, Direct®, Affect® GC. Further examples for anti-drift agents are oils, such as mineral oil, plant oils, methylated seed oil; lecithin; self emulsifiably polyesters; surfactants, such as those mentioned above. Such products are commercially available under the tradenames Termix® 5910, Wheather Guard Complete, Compadre®, Interlock®, Placement®, Silwett® L77, Hasten®, Premium® MSO, Transport® Plus, Point Blank® VM, Agridex®, Meth Oil°, Topcithin® UB, Topcithin® SB.

Examples for thickeners (i.e. compounds that impart a modified flowability to compositions, i.e. high viscosity under static conditions and low viscosity during agitation) are polysaccharides and organic and anorganic clays such as Xanthan gum (Kelzan®, CP Kelco, U.S.A.), Rhodopol® 23 (Rhodia, France), Veegum® (R.T. Vanderbilt, U.S.A.) or Attaclay® (Engelhard Corp., NJ, USA).

Bactericides may be added for preservation and stabilization of the composition. Examples for suitable bactericides are those based on dichlorophene and benzylalcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie).

Examples for suitable anti-freezing agents are ethylene glycol, propylene glycol, urea and glycerin.

Examples for anti-foaming agents are silicone emulsions (such as e.g. Silikon® SRE, Wacker, Germany or Rhodorsil®, Rhodia, France), long chain alcohols, fatty acids, salts of fatty acids, fluoroorganic compounds and mixtures thereof. Preferred anti-foaming agents are silicones, such as polydimethylsiloxan. Silicone based anti-foaming agents are commercially available, e.g. as KM 72 from Shin Etsu, SAG® 220 or SAG® 30 from Momentive, or Antifoam AF-30.

Various types of oils, wetters, adjuvants, herbicides, bactericides, other fungicides and/or pesticides may be added to the pesticide or the compositions comprising them, if appropriate not until immediately prior to use (tank mix). These agents can be admixed with the compositions according to the invention in a weight ratio of 1:100 to 100:1, preferably 1:10 to 10:1. Adjuvants which can be used are in particular polyether modified polysiloxanes such as Break Thru® S 240; fatty alcohol alkoxylates such as Plurafac® LF 120 (BASF) and Lutensol® ON 30 (BASF); EO/PO block polymers, e.g. Pluronic® RPE 2035 and Genapol B alcohol ethoxylates such as Lutensol XP 80®; dioctyl sulfosuccinate sodium such as Leophen RA®, polyvinylalcohols, such as Plurafac® LF 240 (BASF). Especially preferred adjuvants are fatty alcohol alkoxylates and polyether modified polysiloxanes.

Examples of suitable crops are the following:

Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Brassica juncea, Brassica campestris, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera, Zea mays.

Preferred crops are: Arachis hypogaea, Beta vulgaris spec. altissima, Brassica napus var. napus, Brassica oleracea, Brassica juncea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays.

The method according to the invention can preferably be used in genetically modified crops. The term “genetically modified crops” is to be understood as plants, which genetic material has been modified by the use of recombinant DNA techniques in a way that under natural circumstances it cannot readily be obtained by cross breeding, mutations, natural recombination, breeding, mutagenesis, or genetic engineering. Typically, one or more genes have been integrated into the genetic material of a genetically modified plant in order to improve certain properties of the plant. Such genetic modifications also include but are not limited to targeted post-transtional modification of protein(s), oligo- or polypeptides e.g. by glycosylation or polymer additions such as prenylated, acetylated or farnesylated moieties or PEG moieties.

Plants that have been modified by breeding, mutagenesis or genetic engineering, e.g. have been rendered tolerant to applications of specific classes of herbicides, are particularly useful with the composition and method according to the invention. Tolerance to classes of herbicides has been developed such as auxin herbicides such as dicamba or 2,4-D (i.e. auxin tolerant crops); bleacher herbicides such as hydroxyphenylpyruvate dioxygenase (HPPD) inhibitors or phytoene desaturase (PDS) inhibitors; acetolactate synthase (ALS) inhibitors such as sulfonyl ureas or imidazolinones; enolpyruvyl shikimate 3-phosphate synthase (EPSP) inhibitors such as glyphosate; glutamine synthetase (GS) inhibitors such as glufosinate; protoporphyrinogen-IX oxidase (PPO) inhibitors; lipid biosynthesis inhibitors such as acetyl CoA carboxylase (ACCase) inhibitors; or oxynil (i.e. bromoxynil or ioxynil) herbicides as a result of conventional methods of breeding or genetic engineering. Furthermore, plants have been made resistant to multiple classes of herbicides through multiple genetic modifications, such as resistance to both glyphosate and glufosinate or to both glyphosate and a herbicide from another class such as ALS inhibitors, HPPD inhibitors, auxin herbicides, or ACCase inhibitors. These herbicide resistance technologies are, for example, described in Pest Management Science 61, 2005, 246; 61, 2005, 258; 61, 2005, 277; 61, 2005, 269; 61, 2005, 286; 64, 2008, 326; 64, 2008, 332; Weed Science 57, 2009, 108; Australian Journal of Agricultural Research 58, 2007, 708; Science 316, 2007, 1185; and references quoted therein. Examples of these herbicide resistance technologies are also described in US 2008/0028482, US2009/0029891, WO 2007/143690, WO 2010/080829, U.S. Pat. No. 6,307,129, U.S. Pat. No. 7,022,896, US 2008/0015110, U.S. Pat. No. 7,632,985, U.S. Pat. No. 7,105,724, and U.S. Pat. No. 7,381,861, each herein incorporated by reference.

Several cultivated plants have been rendered tolerant to herbicides by conventional methods of breeding (mutagenesis), e.g. Clearfield® summer rape (Canola, BASF SE, Germany) being tolerant to imidazolinones, e.g. imazamox, or ExpressSun® sunflowers (DuPont, USA) being tolerant to sulfonyl ureas, e.g. tribenuron. Genetic engineering methods have been used to render cultivated plants such as soybean, cotton, corn, beets and rape, tolerant to herbicides such as glyphosate, dicamba, imidazolinones and glufosinate, some of which are under development or commercially available under the brands or trade names RoundupReady® (glyphosate tolerant, Monsanto, USA), Cultivance® (imidazolinone tolerant, BASF SE, Germany) and LibertyLink® (glufosinate tolerant, Bayer CropScience, Germany).

Preferably, the crops are genetically modified crops, that are tolerant at least to auxins, in particular crops which are tolerant at least to dicamba or 2,4-D. In a preferred form the crops are tolerant to auxins (e.g. dicamba or 2,4-D) and to glyphosate.

Furthermore, plants are also covered that are by the use of recombinant DNA techniques capable to synthesize one or more insecticidal proteins, especially those known from the bacterial genus Bacillus, particularly from Bacillus thuringiensis, such as ä-endotoxins, e.g. CryIA(b), CryIA(c), CryIF, CryIF(a2), CryIIA(b), CryIIIA, CryIIIB(b1) or Cry9c; vegetative insecticidal proteins (VIP), e.g. VIP1, VIP2, VIP3 or VIP3A; insecticidal proteins of bacteria colonizing nematodes, e.g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxy-steroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be under-stood expressly also as pre-toxins, hybrid proteins, truncated or otherwise modified proteins. Hybrid proteins are characterized by a new combination of protein domains, (see, e.g. WO 02/015701). Further examples of such toxins or genetically modified plants capable of synthesizing such toxins are dis-closed, e.g., in EP-A 374 753, WO 93/007278, WO 95/34656, EP-A 427 529, EP-A 451 878, WO 03/18810 and WO 03/52073. The methods for producing such genetically modified plants are generally known to the person skilled in the art and are described, e.g. in the publications mentioned above. These insecticidal proteins contained in the genetically modified plants impart to the plants producing these proteins tolerance to harmful pests from all taxonomic groups of athropods, especially to beetles (Coeloptera), two-winged insects (Diptera), and moths (Lepidoptera) and to nematodes (Nematoda). Genetically modified plants capable to synthesize one or more insecticidal pro-teins are, e.g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); Bt-Xtra®, NatureGard®, KnockOut®, BiteGard®, Protecta®, Bt11 (e.g. Agrisure® CB) and Bt176 from Syngenta Seeds SAS, France, (corn cultivars producing the Cry1Ab toxin and PAT enzyme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g. EP-A 392 225), plant disease resistance genes (e.g. potato culti-vars, which express resistance genes acting against Phytophthora infestans derived from the mexican wild potato Solanum bulbocastanum) or T4-lyso-zym (e.g. potato cultivars capable of synthesizing these proteins with increased resistance against bacteria such as Erwinia amylvora). The methods for producing such genetically modi-fied plants are generally known to the person skilled in the art and are described, e.g. in the publications mentioned above.

Furthermore, plants are also covered that are by the use of recombinant DNA techniques capable to synthesize one or more proteins to increase the productivity (e.g. bio mass production, grain yield, starch content, oil content or protein content), tolerance to drought, salinity or other growth-limiting environ-mental factors or tolerance to pests and fungal, bacterial or viral pathogens of those plants.

Furthermore, plants are also covered that contain by the use of recombinant DNA techniques a modified amount of substances of content or new substances of content, specifically to improve human or animal nutrition, e.g. oil crops that produce health-promoting long-chain omega-3 fatty acids or unsaturated omega-9 fatty acids (e.g. Nexera® rape, DOW Agro Sciences, Canada).

Furthermore, plants are also covered that contain by the use of recombinant DNA techniques a modified amount of substances of content or new substances of content, specifically to improve raw material production, e.g. potatoes that produce increased amounts of amylopectin (e.g. Amflora® potato, BASF SE, Germany).

Furthermore, it has been found that the tank mix and method according to the invention are also suitable for the defoliation and/or desiccation of plant parts, for which crop plants such as cotton, potato, oilseed rape, sunflower, soybean or field beans, in particular cotton, are suitable. In this regard compositions have been found for the desiccation and/or defoliation of plants, processes for preparing these compositions, and methods for desiccating and/or defoliating plants using the tank mix and method according to the invention.

As desiccants, the tank mix and method according to the invention are suitable in particular for desiccating the above-ground parts of crop plants such as potato, oilseed rape, sunflower and soybean, but also cereals. This makes possible the fully mechanical harvesting of these important crop plants.

Also of economic interest is the facilitation of harvesting, which is made possible by concentrating within a certain period of time the dehiscence, or reduction of adhesion to the tree, in citrus fruit, olives and other species and varieties of pomaceous fruit, stone fruit and nuts. The same mechanism, i.e. the promotion of the development of abscission tissue between fruit part or leaf part and shoot part of the plants is also essential for the controlled defoliation of useful plants, in particular cotton. Moreover, a shortening of the time interval in which the individual cotton plants mature leads to an increased fiber quality after harvesting.

The composition and method according to the invention can be applied pre- or post-emergence, or together with the seed of a crop plant. It is also possible to apply the compounds and compositions by applying seed, pretreated with a composition of the invention, of a crop plant. If the active compounds A and C and, if appropriate C, are less well tolerated by certain crop plants, application techniques may be used in which the herbicidal compositions are sprayed, with the aid of the spraying equipment, in such a way that as far as possible they do not come into contact with the leaves of the sensitive crop plants, while the active compounds reach the leaves of undesirable plants growing underneath, or the bare soil surface (post-directed, lay-by).

The term “growth stage” refers to the growth stages as defined by the BBCH Codes in “Growth stages of mono- and dicotyledonous plants”, 2nd edition 2001, edited by Uwe Meier from the Federal Biological Research Centre for Agriculture and Forestry. The BBCH codes are a well established system for a uniform coding of phonologically simi-lar growth stages of all mono- and dicotyledonous plant species. In some countries related codes are known for specific crops. Such codes may be correlated to the BBCH code as exemplified by Harell et al., Agronomy J. 1998, 90, 235-238.

The tank mix may be allowed to act on crops at any growth stage, such as at BBCH Code 0, 1, 2, 3, 4, 5, 6 and/or 7. Preferably, the tank mix is allowed to act on crops at a growth stage of BBCH Code 0, 1 and/or 2, or their habitat. In another preferred form, the tank mix is allowed to act on crops at a growth stage of BBCH Code 1, 2, 3, 4, 5, 6 and/or 7, especially 2, 3, 4, 5, 6 and/or 7.

The treatment of crop with a pesticide may be done by applying said pesticide by ground or aerial application, preferably by ground application. Suitable application devices are a predosage device, a knapsack sprayer, a spray tank or a spray plane. Preferably the treatment is done by ground application, for example by a predosage device, a knapsack sprayer or a spray tank. The ground application may be done by a user walking through the crop field or with a motor vehicle, preferably with a motor vehicle.

The term “effective amount” denotes an amount of the tank mix, which is sufficient for controlling undesired vegetation and which does not result in a substantial damage to the treated crops. Such an amount can vary in a broad range and is dependent on various factors, such as the species to be controlled, the treated cultivated plant or habitat, the climatic conditions and the pesticide (e.g. auxin herbicide).

The tank mix is typically applied at a volume of 5 to 2000 l/ha, preferably of 50 to 500 l/ha.

The tank mix is typically applied at a rate of 50 to 3000 g/ha auxin herbicide (e.g. dicamba), preferably 200 to 1500 g/ha. In case a further pesticides such as glyphosate is present, the tank mix is typically applied at a rate of 250 to 5000 g/ha further pesticides (e.g. glyphosate).

In another form the tank mix is typically applied at a rate of 5 to 3000 g/ha pesticide (e.g. dicamba), preferably 20 to 1500 g/ha.

The tank mix is typically applied at a rate of 0.1 to 10 kg/ha base (e.g. the carbonate), preferably 0.2 to 5 kg/ha.

In a further embodiment, the composition or method according to the invention can be applied by treating seed. The treatment of seed comprises essentially all procedures familiar to the person skilled in the art (seed dressing, seed coating, seed dusting, seed soaking, seed film coating, seed multilayer coating, seed encrusting, seed dripping and seed pelleting) based on the composition and method according to the invention. Here, the herbicidal compositions can be applied diluted or undiluted.

The term seed comprises seed of all types, such as, for example, corns, seeds, fruits, tubers, seedlings and similar forms. Here, preferably, the term seed describes corns and seeds.

The seed used can be seed of the useful plants mentioned above, but also the seed of transgenic plants or plants obtained by customary breeding methods.

The rates of application of the active compound are from 0.0001 to 3.0, preferably 0.01 to 1.0 kg/ha of active substance (a.s.), depending on the control target, the season, the target plants and the growth stage. To treat the seed, the pesticides are generally employed in amounts of from 0.001 to 10 kg per 100 kg of seed.

The present invention also relates to an aqueous tank mix as defined above comprising a pesticide (e.g. auxin herbicide), a base and water. Suitable and preferred forms of the pesticide (e.g. auxin herbicide), base or water are given above.

The present invention also relates to a method for preparing an aqueous tank mix as defined in above comprising the step of contacting a pesticide (e.g. auxin herbicide), a base, water and optionally an auxiliary. This method may be identical to the above mentioned step A). Suitable and preferred forms of the pesticide (e.g. auxin herbicide), base or water are given above. The contacting may be achieved by mixing the components in any sequence. Preferably, the contacting is done at ambient temperature, such as from 5 to 45° C.

The present invention also relates to a use of the base for preparing the aqueous tank mix which has a tank mix acidity of at least pH 5.0. Preferably, the base contains a carbonate and/or a phosphate. More preferably, the base contains an alkali salt of hydrogencarbonate, an alkali salt of carbonate, or a mixture thereof. Preferably, the use is for controlling the pH value of the tank mix.

The invention offers various advantages: There is a very low rate of unwanted phytotoxic damage in neighbouring areas in which other crops (e.g. dicotyledon crops) grow. Further on, the herbicidal effect of the auxin herbicide is increased; the pesticidal effect of the pesticide is increased; the tank mix adjuvants are easy and safe to handle and to apply; the volatility of pesticides (e.g. auxin herbicides) is decreased; the efficacy of pesticides (e.g. glyphosate), which are sensitive to multivalent cations like Ca²⁺ or Mg²⁺ is conserved; the invention is very safe to crops; the volatility of pesticides (e.g. auxin herbicides) is preserved or even decreased also after addition of anionic pesticides comprising mono- or diamine cations (e.g. isopropylamine glyphosate, dimethylamine glyphosate, ammonium glyphosate).

### EXAMPLES

Surfactant A: Nonionic C8/10 alkylpolyglycosid (about 70 wt % active content and 30 wt % water), viscous liquid, water-soluble, HLB 13-14.
Surfactant B: Nonionic, branched, ethoxylated alkylamine, soluble in water.
Additive A: Water-soluble sodium salt of polyacrylic acid, molar mass 7-10 kDa, K-value about 25-30, solution in water (45 wt %).
Antidrift A: Termix® 5910, commercially available from Huntsman, liquid at 25° C., density at 25° C. 0.99 g/ml; pour point −28° C., pH 6-8 (1% in water), viscosity 207 mPas (20° C.).
Clarity®: Agrochemical formulation of dicamba salt of 2-(-aminoethoxy)ethanol (watersoluble concentrate SL, 480 g/l, commercially available from BASF Cooperation).
Banvel®: Agrochemical formulation of dicamba salt of dimethylamine (watersoluble concentrate SL, 48.2 wt %, commercially available from BASF Cooperation).
Touchdown® HiTech: Agrochemical formulation of glyphosate potassium salt (watersoluble concentrate SL, 500 g/l, commercially available from Syngenta).

### Example 1

### Preparation of Liquid Tank Mix Adjuvant Containing a Base

a) 400 g K₂CO₃ and 40 g KHCO₃ were dissolved in water at room temperature and filled up with water to a volume of 1.0 l. The aqueous solution had a pH of 11.
b) 200 g KHCO₃ was dissolved in water at room temperature and filled up with water to a volume of 1.0 l. The aqueous solution had a pH of 8 to 9.
c) 400 g K₂CO₃ was dissolved in water at room temperature and filled up with water to a volume of 1.0 l. The aqueous solution had a pH of 12.
d) 300 g K₂CO₃, 300 g Surfactant A and 10 g Antidrift A were dissolved in water at room temperature and filled up with water to a volume of 1.0 l. The aqueous solution had a pH of 12.
e) 250 g K₂CO₃, 300 g Surfactant A and 10 g Antidrift A were dissolved in water at room temperature and filled up with water to a volume of 1.0 l. The aqueous solution had a pH of 12.
f) 250 g K₂CO₃, 25 g KHCO₃, 25 g Surfactant B and 150 g Surfactant A were dissolved in water at room temperature and filled up with water to a volume of 1.0 l. The aqueous solution had a pH of 11.
g) 270 g K₂CO₃, 30 g KHCO₃, 10 g Additive A are dissolved in water at room temperature and filled up with water to a volume of 1.0 l.
h) 300 g K₂CO₃ and 10 g Additive A are dissolved in water at room temperature and filled up with water to a volume of 1.0 l.
i) 200 g KH₂PO₄ and 10 g Additive A are dissolved in water at room temperature and filled up with water to a volume of 1.0 l.
j) 200 g K₂HPO₄ and 10 g Additive A are dissolved in water at room temperature and filled up with water to a volume of 1.0 l.

### Example 2

### Preparation of Granulated Tank Mix Adjuvant Containing a Base

A mixture of 900 g K₂CO₃ and 100 g KHCO₃ were provided in a fluidized bed granulator. 100 ml of a 10 wt % aqueous suspension of kaolin were sprayed into the fluidized bed. Water was simultaneously removed by a stream of hot air (100° C.). After sieving a dried particulated product was obtained with a particle size D₉₀ below 10 mm.

### Example 3

### Preparation of Particulated Tank Mix Adjuvant Containing a Base

900 g K₂CO₃ and 100 g KHCO₃ were dry mixed in a mixing plant. After sieving a homogenous mixture was obtained with a with a particle size D₉₀ below 10 mm.

### Example 4

### Preparation of Tank Mix

A sprayable tank mix is prepared by mixing at 20° C. while stirring a commercial SL formulation (Clarity®, Banvel®, or Touchdown® Hitech), water, and the tank mix adjuvants of Examples 1, 2, or 3. The concentration of the pesticide is 1, 5, or 15 g/l, respectively, and the concentration of the dissolved base is 3, 30 or 50 g/l, respectively, in the tank mix.

### Example 5

### Preparation of Tankmix

### Comparative Examples a) to d)

a) An aqueous formulation (SL type) containing potassium glyphosate was mixed with water and tallowamine ethoxylate (15 EO). The tank mix contained 0.67 g/l glyphosate and 0.8 g/l of the tallowamine ethoxylate.
b) An aqueous formulation (SL type) containing potassium glyphosate was mixed with water and tallowamine ethoxylate (15 EO). The tank mix contained 0.33 g/l glyphosate and 0.8 g/l of the tallowamine ethoxylate.
c) An aqueous formulation (SL type) containing potassium glyphosate was mixed with water and tallowamine ethoxylate (5 EO). The tank mix contained 0.67 g/l glyphosate and 0.8 g/l of the tallowamine ethoxylate.
d) An aqueous formulation (SL type) containing potassium glyphosate was mixed with water and tallowamine ethoxylate (5 EO). The tank mix contained 0.33 g/l glyphosate and 0.8 g/l of the tallowamine ethoxylate.

### Inventive Examples e) to h)

e) An aqueous formulation (SL type) containing potassium glyphosate was mixed with water, K₂CO₃ and tallowamine ethoxylate (15 EO). The tank mix contained 0.67 g/l glyphosate, 0.8 g/l of the tallowamine ethoxylate, and 2.67 g/l K₂CO₃.
f) An aqueous formulation (SL type) containing potassium glyphosate was mixed with water, K₂CO₃ and tallowamine ethoxylate (15 EO). The tank mix contained 0.33 g/l glyphosate, 0.8 g/l of the tallowamine ethoxylate and 2.67 g/l K₂CO₃.
g) An aqueous formulation (SL type) containing potassium glyphosate was mixed with water, K₂CO₃ and tallowamine ethoxylate (5 EO). The tank mix contained 0.67 g/l glyphosate, 0.8 g/l of the tallowamine ethoxylate and 2.67 g/l K₂CO₃.
h) An aqueous formulation (SL type) containing potassium glyphosate was mixed with water, K₂CO₃ and tallowamine ethoxylate (5 EO). The tank mix contained 0.33 g/l glyphosate, 0.8 g/l of the tallowamine ethoxylate and 2.67 g/l K₂CO₃.

### Example 6

### Biological Evaluation

For the greenhouse tests, maize (cultivar Amadeo) and Chenopodium album was sown or potted in loamy sandy soil to a depth of 1-2 cm. When the plants had reached a growth height of 10 to 25 cm (around 10 to 21 days after sowing), the spray mixtures were applied to the plants in a spraying cabin.

The tank mixes prepared in Example 5 were applied at an application rate of 375 l/ha (140 or 280 g of glyphosate free acid/ha and 300 g of adjuvant/ha). The adjuvant Ad1 is an aqeuous solution of 200 g/l Genamin® T150 (a tallow fatty amine ethoxylate with 15 EO). The adjuvant Ad2 is Genamin® T050 (a tallow fatty amine ethoxylate with 5 EO).

The temperatures in the experimental period, which lasted for 3 to 4 weeks, were between 18-35° C. During this time, the experimental plants received optimum watering, with nutrients being supplied via the water used for watering.

The herbicidal activity was evaluated by awarding scores to the treated plants in comparison to the untreated control plants (Table 1 and 2). The evaluation scale ranges from 0% to 100% activity. 100% activity means the complete death at least of those parts of the plant that are above ground. Conversely, 0% activity means that there were no differences between treated and untreated plants. The results demonstrated the increased activity of the active substance as a result of addition of the adjuvant.

TABLE 1
Activity [%] after 21 days DAT (125 g/ha application rate of active)

| | Maize Amadeo |
|---|---|
| Gly-K + Ad1^{a)} | 57 |
| Gly-K + Ad1 + K₂CO₃ | 82 |
| Gly-K + Ad2^{a)} | 55 |
| Gly-K + Ad2 + K₂CO₃ | 65 |

^{a)}Comparative experiment.

TABLE 2
Activity [%] after 21 days DAT (250 g/ha application rate of active)

| | Chenopodium album |
|---|---|
| Gly-K + Ad1^{a)} | 87 |
| Gly-K + Ad1 + K₂CO₃ | 91 |
| Gly-K + Ad2^{a)} | 80 |
| Gly-K + Ad2 + K₂CO₃ | 98 |

^{a)}Comparative experiment.

### Example 7

### Biological Evaluation

The biological evaluation was made as described in Example 6. The water used was hard water having a hardness of 25° dH. A tank mix (“Mix A”) was applied with an application volume of 100 l/ha and with an application rate of 125 g/ha potassium glyphosate, 62.5 g/ha sodium dicamba, 300 g/ha Genamin® T150, 300 g/l Preference® (an alkylphenol ethoxylate, sodium salt of soya fatty acid, isopropyl alcohol) and optionally 1000 g/ha K₂CO₃ (“Mix A+K₂CO₃”). The results are summarized in Table 3.

TABLE 3
Activity [%]

| Plant | DAT | Mix A^{a)} | Mix A + K₂CO₃ |
|---|---|---|---|
| Sorghum halepense | 7 | 60 | 88 |
| Sorghum halepense | 14 | 55 | 92 |
| Sorghum halepense | 21 | 50 | 92 |
| Eleusine gracilis | 7 | 73 | 78 |
| Eleusine gracilis | 14 | 78 | 92 |
| Eleusine gracilis | 21 | 80 | 97 |
| Chenopodium album | 7 | 75 | 82 |
| Chenopodium album | 14 | 87 | 90 |
| Chenopodium album | 21 | 93 | 97 |
| Zea mays (Amadeo) | 7 | 20 | 52 |
| Zea mays (Amadeo) | 14 | 37 | 68 |
| Zea mays (Amadeo) | 21 | 42 | 80 |

^{a)}Comparative experiment.

### Example 8

### Biological Evaluation of Low Phytotoxicity

The biological evaluation was made as described in Example 6. The tank mixes were applied at a application rate of 375 l/ha (125 or 250 g of glyphosate free acid/ha and 300 g of adjuvant/ha). The adjuvant Ad1 is an aqeuous solution of 200 g/l Genamin® T150 (a tallow fatty amine ethoxylate with 15 EO). The adjuvant Ad2 is Genamin® T050 (a tallow fatty amine ethoxylate with 5 EO). The results are summarized in Table 4.

Soya (glycine max) Variant Deltapine was genetically engineered to resist glyphosate. These data demonstrated that the addition of K₂CO₃ has no phytotoxity effect on plants.

TABLE 4
Activity [%] after 7 DAT (days after treatment)

| | Soya Deltapine | Soya Deltapine |
|---|---|---|
| | 125 g/ha Active | 250 g/ha Active |
| Gly-K + Ad1^{a)} | 5 | 5 |
| Gly-K + Ad1 + K₂CO₃ | 5 | 7 |
| Gly-K + Ad2^{a)} | 5 | 5 |
| Gly-K + Ad2 + K₂CO₃ | 2 | 5 |

^{a)}Comparative experiment.

### Example 9

### Volatility

The volatility was determined by analyzing the loss of material by HLPL at 70° C. after 24 h at atmospheric pressure. A sample of the aqueous tank mix (300 l/ha) was placed on the petri dish with a defined area (corresponding to a desired field application rate, such as 500 g/ha pesticide). The loss is summarized in Table 5.

TABLE 5
Loss of dicamba, application rate 500 g/ha dicamba

| | pH of tank mix | Loss (wt %) |
|---|---|---|
| Dicamba free acid^{a)} | 3.0 | 80 |
| Banvel ®^{a)} | 6.0 | 86 |
| Clarity ®^{a)} | 5.4 | 3.7 |
| Clarity ® + 0.5 eq. KHCO₃ | 7.6 | 2.3 |
| Clarity ® + 1.0 eq. KHCO₃ | 7.8 | 2.5 |
| Clarity ® + 2.0 eq. KHCO₃ | 8.0 | 0.1 |
| Clarity ® + 4.0 eq. KHCO₃ | 8.2 | <0.1 |

^{a)}Comparative experiment.

### Example 10

### Volatility

The volatility was determined like in Example 9 and the loss is summarized in Table 6. The application rate was 500 g/ha dicamba (free acid), 1000 g/ha potassium glyphosate, 300 g/ha Genamin® T050 (“Ad2”), 300 g/ha Preference® (“Ad3”) and optionally 250, 500 or 1000 g/ha K₂CO₃. Deionised water (hardness <1° dH) was used to prepare the samples. Dicamba BAPMA refers to the bis(3-aminopropyl)methylamine salt of dicamba.

TABLE 6
Loss of dicamba

| | pH of | Loss |
|---|---|---|
| | tank mix | (wt %) |
| Dicamba BAPMA^{a)} | 6.3 | <1 |
| Dicamba BAPMA + Gly-K + Ad2 + Ad3^{a)} | 5 | 15 |
| Dicamba BAPMA + Gly-K + Ad2 + Ad3 + 250 g/ | 6 | 6 |
| ha K₂CO₃ | | |
| Dicamba BAPMA + Gly-K + Ad2 + Ad3 + 500 g/ | 7 | <4 |
| ha K₂CO₃ | | |
| Dicamba BAPMA + Gly-K + Ad2 + Ad3 + 1000 g/ | 9 | <3 |
| ha K₂CO₃ | | |

^{a)}Comparative experiment.

### Example 11

### Preparation of Tankmix

A tank mix is prepared (applicable at a rate of 100 l/ha) by mixing 1000 g potassium glyphosate, 0.83 l of bis(3-aminopropyl)methylamine salt of dicamba in water (600 g/l dicamba content), 300 g Preference®, and 2.0 l of the liquid tank mix adjuvant from Example 1 h) in 60 l water (hardness 10° dH), and filling up with the water to a final volume of 100 l.

1-15. (canceled)

16. A method of controlling undesired vegetation which comprises
A) preparing an aqueous tank mix which has a tank mix acidity of at least pH 7.0 comprising contacting a pesticide formulation, water, a base, and optionally an auxiliary; and
B) allowing a pesticidal effective amount of the tank mix to act on crops, their habitat, on the undesired vegetation, on the respective pests, and/or on seed of said crops,
wherein the base contains a carbonate and/or a phosphate,
wherein the base has a solubility in water of at least 1 g/l at 20° C.,
wherein the pesticide is dissolved in the tank mix, and
wherein the pesticide formulation contains
an auxin herbicide selected from indole-3-acetic acid (IAA), phenyl acetic acid (PAA), 4-chloroindole-3-acetic acid (4-Cl-IAA), indole-3-butanoic acid (IBA), 2,4-D, 2,4-DB, aminopyralid, benazolin, chloramben, clomeprop, clopyralid, dicamba, dichlorprop, dichlorprop-P, fluroxypyr, MCPA, MCPA-thioethyl, MCPB, mecoprop, mecoprop-P, picloram, quinclorac, quinmerac, TBA (2,3,6), triclopyr, aminocyclopyrachlor, and the salts of the auxin herbicide; and/or
an anionic organophosphorous herbicide selected from bialafos, glufosinate, glufosinate-P, and glyphosate.

17. The method according to claim 16, wherein in step B) the tank mix is allowed to act on crops at their growth stage of BBCH Code 1, 2, 3, 4, 5, 6 and/or 7.

18. The method according to claim 16, wherein the water contains at least 0.1 mmol/l of the sum of calcium ions and magnesium ions.

19. The method according to claim 16, wherein the base contains an alkali or earth alkali salt of carbonate or hydrogencarbonate.

20. The method according to claim 16, wherein the base contains an alkali salt of hydrogencarbonate.

21. The method according to claim 16, wherein the tank mix acidity corresponds to a pH in the range from 8.0 to 13.0.

22. The method according to claim 16, wherein the tank mix is applied at a rate of 100 to 10000 g/ha base.

23. The method according to claim 16, wherein the pesticide comprises an auxin herbicide selected from dicamba and its salts, and 2,4-D and its salts.

24. The method according to claim 16, wherein the crops are auxin-tolerant crops.

25. The method according to claim 16, wherein the auxiliary comprises a surfactant, an anti-freezing agent, a crystallization inhibitor, and/or an anti-foaming agent.

26. The method according to claim 16, wherein the auxiliary comprises a crystallization inhibitor selected from polyacrylic acids and their salts.

27. A method for preparing an aqueous tank mix as defined in claim 16 which has a tank mix acidity of at least pH 7.0,
wherein the base contains a carbonate and/or a phosphate,
wherein the base has a solubility in water of at least 1 g/l at 20° C.,
wherein the pesticide is dissolved in the tank mix, and
wherein the pesticide formulation contains
an auxin herbicide selected from indole-3-acetic acid (IAA), phenyl acetic acid (PAA), 4-chloroindole-3-acetic acid (4-Cl-IAA), indole-3-butanoic acid (IBA), 2,4-D, 2,4-DB, aminopyralid, benazolin, chloramben, clomeprop, clopyralid, dicamba, dichlorprop, dichlorprop-P, fluroxypyr, MCPA, MCPA-thioethyl, MCPB, mecoprop, mecoprop-P, picloram, quinclorac, quinmerac, TBA (2,3,6), triclopyr, aminocyclopyrachlor, and the salts of the auxin herbicide; and/or
an anionic organophosphorous herbicide selected from bialafos, glufosinate, glufosinate-P, and glyphosate.

28. The method according to claim 27, wherein the base contains an alkali or earth alkali salt of carbonate or hydrogencarbonate.

29. The method according to claim 27, wherein the base contains an alkali salt of hydrogencarbonate, an alkali salt of carbonate, or a mixture thereof.

30. The method according to claim 27, wherein the pesticide comprises an auxin herbicide selected from dicamba and its salts, and 2,4-D and its salts.
